(19) United States
(12) Patent Application Publication
(10) Pub. No.: US 2015/0029104 A1
(43) Pub. Date: Jan. 29, 2015

(54) ELECTRONIC DEVICE AND POINTING DEVICE CONTROL METHOD

(71) Applicant: KABUSHIKI KAISHA TOSHIBA, Tokyo (JP)

(72) Inventors: Takehiro HORI, Ome-shi (JP); Masaya ENDO, Higashiyamato-shi (JP); Taku NARUSE, Ome-shi (JP)

(73) Assignee: KABUSHIKI KAISHA TOSHIBA, Tokyo (JP)

(21) Appl. No.: 14/282,936

(22) Filed: May 20, 2014

Related U.S. Application Data
(60) Provisional application No. 61/858,326, filed on Jul. 25, 2013.

(51) Int. Cl. G06F 3/0354

(52) U.S. Cl. CPC G06F 3/03543
USPC 345/163

(57) ABSTRACT

According to one embodiment, an electronic device includes an input, an output and a controller. The input receives operation information corresponding to an operation of a pointing device. The output outputs an image to be displayed on a display. The controller sets a plurality of divisional areas on a screen of the display in accordance with a resolution of the display, and moves a mouse pointer in units of a divisional area of the plurality of divisional areas in accordance with the operation information.

### CROSS-REFERENCE TO RELATED APPLICATIONS

This application claims the benefit of U.S. Provisional Application No. 61/858,326, filed Jul. 25, 2013; the entire contents of which are incorporated herein by reference.

### FIELD

Embodiments described herein relate generally to a control of a pointing device.

### BACKGROUND

An electronic device such as a personal computer is provided with a pointing device such as a mouse or a touchpad. If the pointing device is operated by a user, the electronic device moves a display position of a mouse pointer (or a mouse cursor) which is displayed on a screen, in accordance with a direction of operation. Thereby, the user can designate an object such as an icon which is displayed on the screen, by using the mouse pointer.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view illustrating an external structure of an electronic device according to an embodiment.

FIG. 2 is an exemplary view illustrating a functional configuration of a personal computer according to the embodiment.

FIG. 3 is an exemplary view illustrating a program stored in a storage module in the embodiment.

FIG. 4 is an exemplary view illustrating a state transition of the personal computer and program in the embodiment.

FIG. 5 is an exemplary view illustrating a state of movement of a mouse pointer in a state S1 in the embodiment.

FIG. 6 is an exemplary view illustrating a state of movement of the mouse pointer in a state S2 in the embodiment.

FIG. 7 is an exemplary flowchart illustrating an operation of a utility in the embodiment.

FIG. 8 is an exemplary flowchart illustrating the details of a process of drawing a mouse pointer in units of a divisional area in a divisional area display mode in the embodiment.

FIG. 9 is an exemplary view which conceptually illustrates a calculation method of a position of drawing of a mouse pointer in the embodiment.

FIG. 10 is an exemplary view illustrating a state transition of the personal computer and program in the embodiment.

FIG. 11 is an exemplary flowchart illustrating an operation of the utility in the embodiment.

FIG. 12 is an exemplary view illustrating a display example of a screen in the embodiment.

FIG. 13 is an exemplary view illustrating a display example of the screen in the embodiment.

FIG. 14 is an exemplary view illustrating a display example of the screen in the embodiment.

FIG. 15 is an exemplary view illustrating a display example of the screen in the embodiment.

### DETAILED DESCRIPTION

Various embodiments will be described hereinafter with reference to the accompanying drawings.

In general, according to one embodiment, an electronic device includes an input, an output and a controller. The input receives operation information corresponding to an operation of a pointing device. The output outputs an image to be displayed on a display. The controller sets a plurality of divisional areas on a screen of the display in accordance with a resolution of the display, and moves a mouse pointer in units of a divisional area of the plurality of divisional areas in accordance with the operation information.

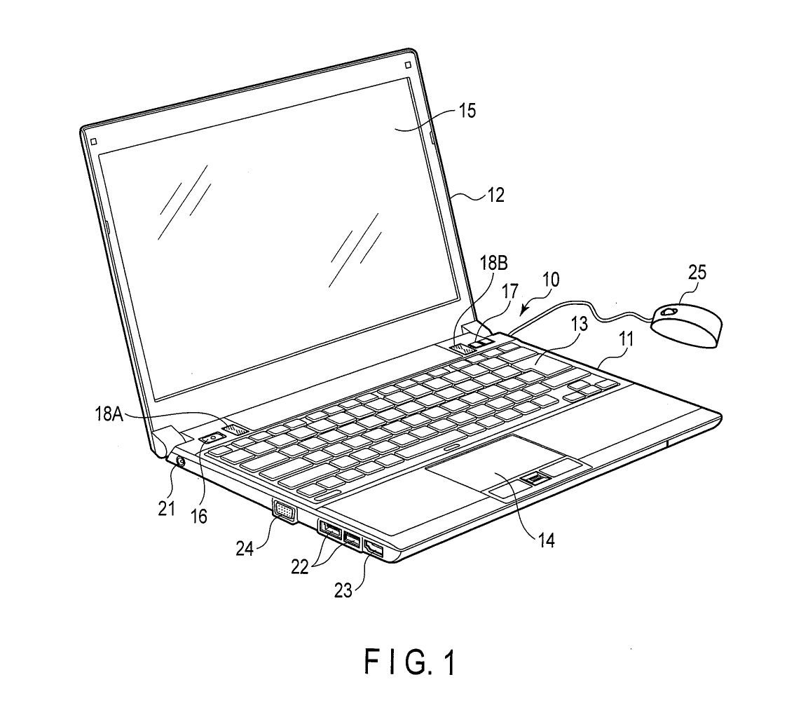

FIG. 1 is a view illustrating an external structure of an electronic device according to an embodiment. The electronic device can be realized as a notebook-type personal computer, a tablet terminal, a desktop-type personal computer, a television apparatus, an HDD recorder, or other various electronic devices. In the description below, the case is assumed that the electronic device is realized as a notebook-type personal computer 10.

FIG. 1 is a perspective view of the personal computer 10. The personal computer 10 includes a first housing 11 and a second housing 12. A display 15, such as a liquid crystal display (LCD), is assembled in the second housing 12.

The second housing 12 is attached to the first housing 11 rotatable between an open position where the top surface of the first housing 11 is exposed, and a closed position where the top surface of the first housing 11 is covered with the second hosing 12. The first housing 11 includes a thin box-shaped housing. A keyboard 13, a touchpad 14, a power switch 16 for powering on/off the personal computer 10, some function buttons 17, and speakers 18A and 18B are disposed on the top surface of the first housing 11.

In addition, a power connector 21, to which an external power supply device is detachably attached, is provided on a side surface of the first housing 11. As the external power supply device, use may be made of an AC adapter which converts commercial power (AC power) to DC power.

Furthermore, the first housing 11 is provided with some USB ports 22, an HDMI (High-Definition Multimedia Interface) output terminal 23, and an RGB port 24. A mouse 25, which is used as a pointing device, is connected to one USB port 22. For example, a plurality of mouse buttons (a right button, a left button, etc.) are provided on the mouse 25. Besides, an external display (display unit) can be connected to the RGB port 24. The external display is used in order to display a screen which is different from a screen that is displayed on the display 15, or to display, together with the display 15, a logically single screen.

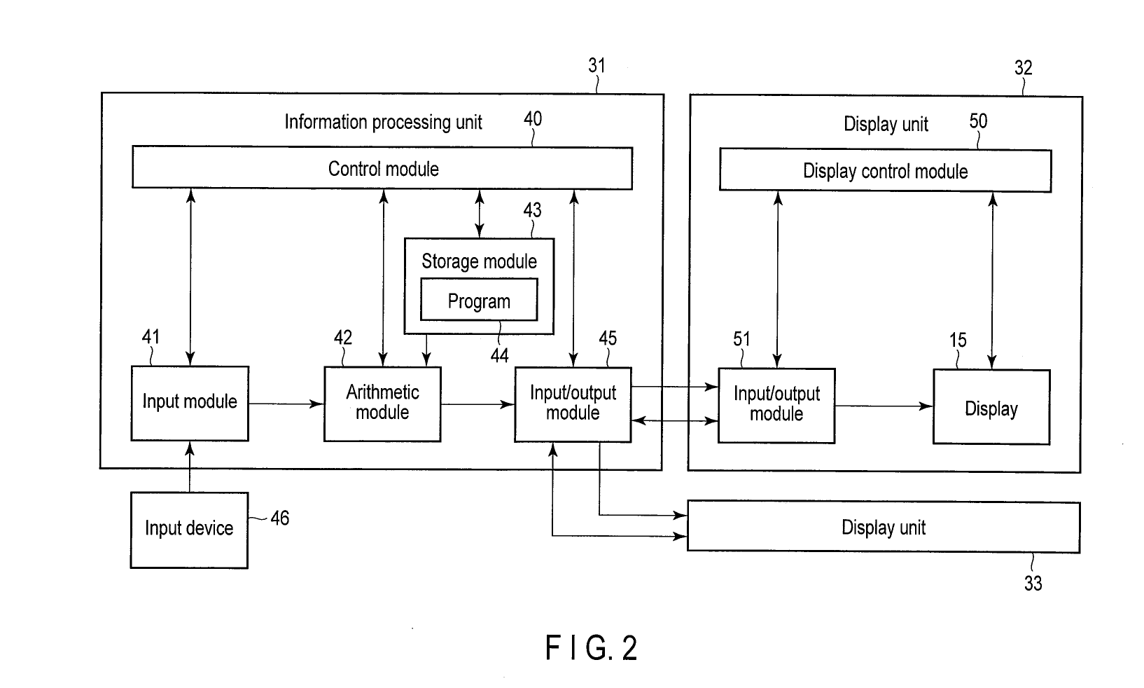

FIG. 2 illustrates a functional configuration of the personal computer 10 in the embodiment. The personal computer 10 includes an information processing unit 31 and a display unit 32. The information processing unit 31 executes various information processes, based on various programs. The information processing unit 31 includes a control module (controller) 40, an input module 41, an arithmetic module 42, a storage module 43 and an input/output module 45.

The control module 40 executes overall control of the personal computer 10, and is realized by executing, by a processor or the like, a program 44 which is stored in the storage module 43.

The input module 41 controls a data input corresponding to an operation of an input device 46 by the user. The input device 46 includes the keyboard 13, touchpad 14, mouse 25, and various buttons.

The arithmetic module 42 executes an arithmetic operation for responding to an input from the input module 41. The arithmetic module 42 is realized by executing, by the processor or the like, the program 44 which is stored in the storage module 43. The arithmetic module 42 communicates with the input/output module 45, where necessary, and outputs an image signal of an image (picture), which is to be displayed on the display 15, to the display unit 32.

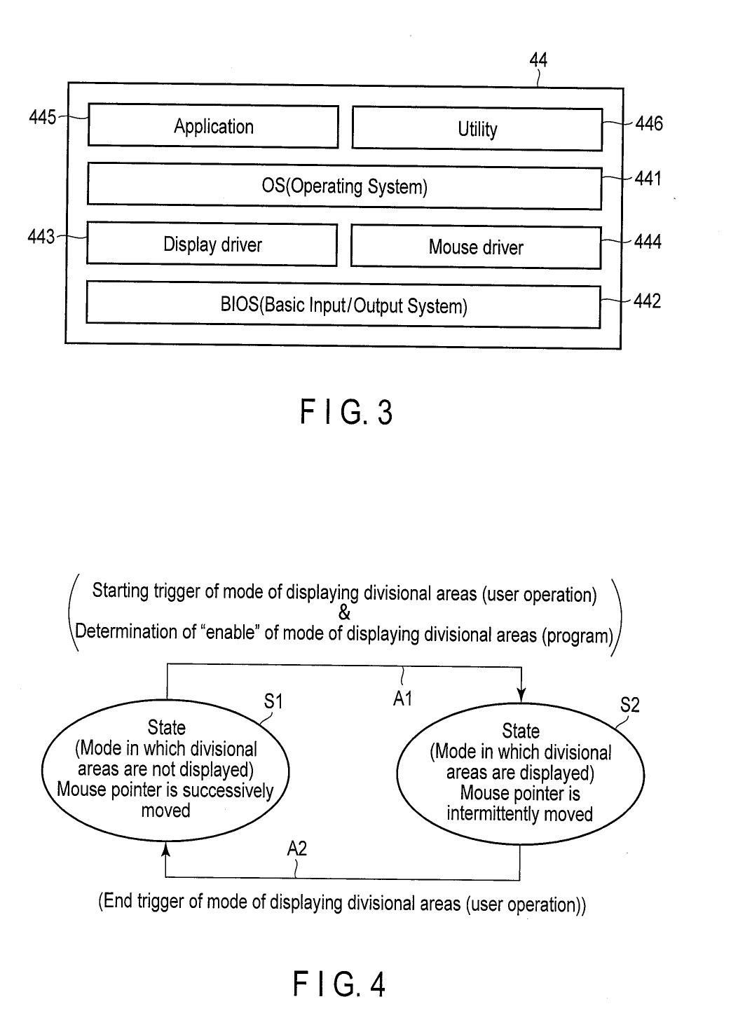

The storage module 43 stores various programs and data, and includes a ROM (Read Only Memory), a RAM (Random Access Memory), a hard disk drive (HDD) and an optical disc drive (ODD). Examples of the program 44 stored in the storage module 43 are shown in FIG. 3.

The input/output module 45 outputs an image signal of an image (picture), which is to be displayed on the display 15, to the display unit 32.

The display unit 32 displays the image (picture) under the control of the information processing unit 31. The display unit 32 includes an input/output module 51 which receives an image signal from the information processing unit 31 (input/output module 45), and a display control module 50 which drives the display 15, based on the image signal received from the input/output module 51, and displays the image (picture).

In the meantime, a display unit 33 is used as an external display, and has the same function as the display unit 32. When the display unit 33 is connected to the RGB port 24, the input/output module 45 outputs to the display unit 33 an image signal of the image (picture) which is to be displayed on the display of the display unit 33.

FIG. 3 illustrates examples of the program 44 stored in the storage module 43 in the embodiment.

As shown in FIG. 3, the storage module 43 stores programs such as an OS (Operating System) 441, a BIOS (Basic Input/Output System) 442, a display driver 443, a mouse driver 444, an application 445 and a utility 446.

The OS 441 is a basic program for managing the system of the personal computer 10 and providing a basic user environment. The OS 441 manages, as system information, for example, data of the resolution of the display of the display unit 32 provided in the personal computer 10 and the resolution of the display of the display unit 33 which is connected as the external display. In addition, the OS 441 can mange a DPI setup value indicative of an enlargement ratio of icons and characters on the screen, and can provide the DPI setup value to other programs (e.g. utility 446). The enlargement ratio of icons and characters can be varied by a user operation.

The display driver 443 controls display of the display unit 32 (display unit 33) under the control of the OS 441.

The mouse driver 444 controls the pointing devices (mouse 25 and touchpad 14) under the control of the OS 441, and inputs data corresponding to a user operation.

The application 445 is a program for realizing a process for a specific purpose, and includes a browser program, a word-processing program, a presentation program, and a spreadsheet program, etc.

The utility 446 controls a movement of a mouse pointer which is displayed on the screen, in accordance with a user operation of the pointing device. When a predetermined user operation has been executed, the utility 446 executes a transition to a mode in which the mouse pointer is quickly moved, by using this user operation as a starting trigger. In the present embodiment, when a transition has been made to the mode in which the mouse pointer is quickly moved, the utility 446 displays a plurality of divisional areas into which the screen of the display is divided. In the description below, the mode in which the mouse pointer is quickly moved is described as a divisional area display mode.

FIG. 4 is a state transition diagram of the personal computer 10 and the program 44 executed by the personal computer 10 in the embodiment.

The personal computer 10 and program 44 make a transition between a state S1 and a state S2 in accordance with conditions A1 and A2 of the user.

The state S1 is a state which is not in the divisional area display mode, and the state S2 is a state of the divisional area display mode.

The condition A1 for a transition from the state S1 to state S2 is a condition that a trigger for starting the mode of displaying the divisional areas has occurred as a user operation and the result of the “enable/disable” determination of the mode of displaying the divisional areas by the program (utility 446) is indicative of “enable”.

The condition A2 for a transition from the state S2 to state S1 is a condition that a trigger for ending the mode of displaying the divisional areas has occurred as a user operation.

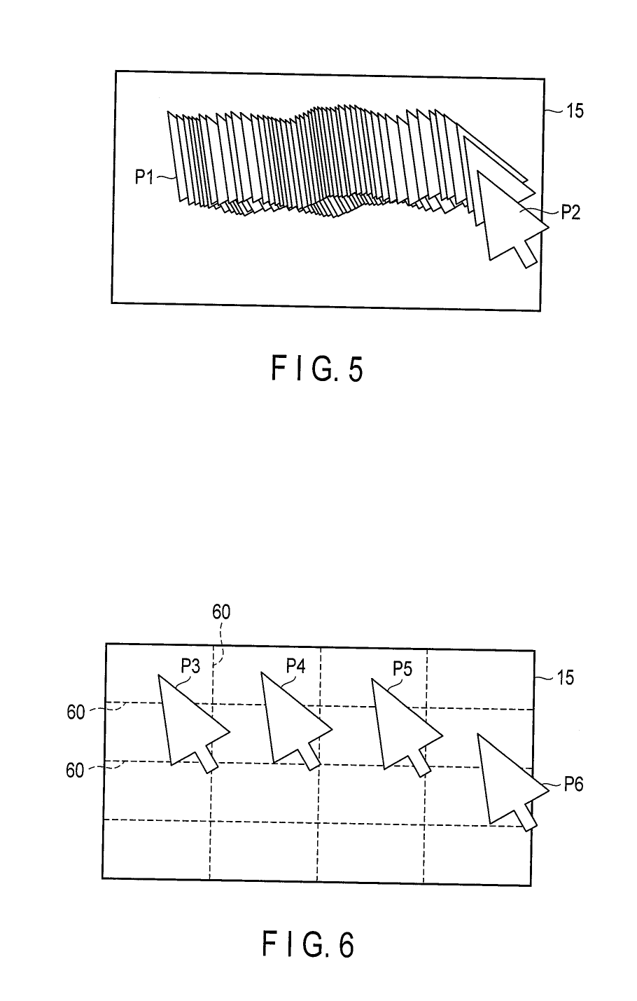

FIG. 5 illustrates an example of the state of movement of the mouse pointer at a time when the user has operated the pointing device in the state S1 (the state that is not in the divisional area display mode). In FIG. 5, for the purpose of easier understanding, the size of the mouse pointer is enlarged, and FIG. 5 illustrates the mouse pointer which is displayed while the mouse point is moved from a position of mouse pointer P1 to a position of mouse pointer P2.

As illustrated in FIG. 5, in the state S1, by the pointing device being operated, the mouse pointer P1 is successively moved in units of a number of pixels corresponding to the operation amount of the pointing device. Accordingly, when the resolution of the display 15 is high (the number of pixels is large), as shown in FIG. 5, it is necessary to increase the operation amount of the pointing device, in order to greatly move the mouse pointer. In addition, in the state S1, since the mouse pointer can be finely moved, an object such as an icon can easily be designated by the mouse pointer.

FIG. 6 illustrates an example of the state of movement of the mouse pointer at a time when the user has operated the pointing device in the state S2 (the state of the divisional area display mode). As shown in FIG. 6, in the state S2, divisional areas are set by drawing lines 60 for demarcating the divisional areas. For example, 16 divisional areas are set by dividing the screen of the display 15 by four in the vertical and horizontal directions.

As illustrated in FIG. 6, in the state S2, by the pointing device being operated, a mouse pointer P3 is intermittently moved in units of a divisional area in accordance with a predetermined operation amount of the pointing device. FIG. 6 illustrates mouse pointers P4 and P5 which are intermittently displayed while the mouse pointer is moved from a position of mouse pointer P3 to a position of mouse pointer P6. Accordingly, even when the resolution of the display 15 is high (the number of pixels is large), the operation amount of the pointing device, which is necessary for moving the mouse pointer in units of a divisional area, is properly set. Thereby, as shown in FIG. 6, even when the mouse pointer is to be greatly moved, it is not necessary to increase the operation amount of the pointing device. In the example shown in FIG. 6, the mouse pointers P3 to P6 are displayed at such positions as to point the central coordinates of the respective divisional areas.

In the personal computer 10 of the embodiment, when the mouse pointer in the screen is to be greatly moved, the divisional area display mode (state S2) is used and the mouse pointer is moved to a target divisional area. Thereafter, the divisional area display mode is released (i.e. transition to state S1). Thereby, an operation on an object such as an icon in the target divisional area can easily be performed.

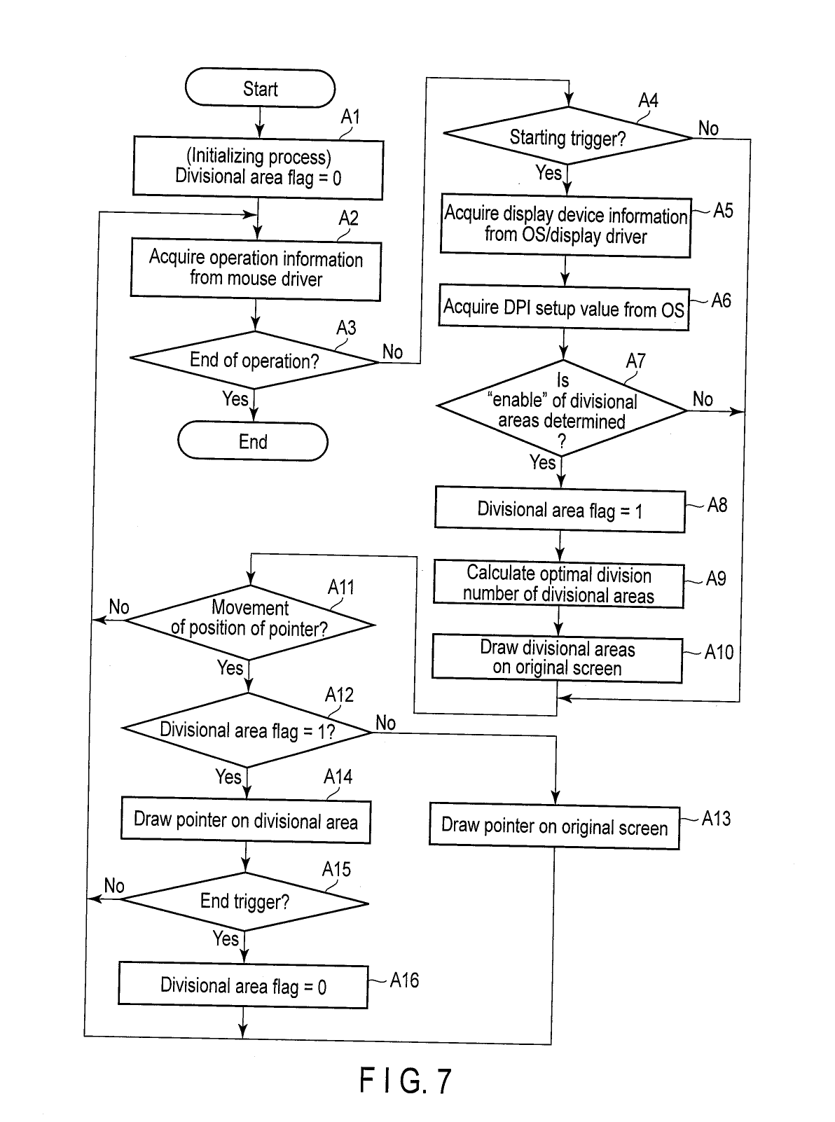

Next, a description is given of an operation of mouse pointer control in the divisional area display mode of the embodiment. FIG. 7 is a flowchart illustrating an operation of the utility 446 in the embodiment. The personal computer 10 realizes the process of the flowchart of FIG. 6 by executing the utility 446 by the processor or the like. The description below is given of the operation of the utility 446.

In FIG. 7, steps A1, A2 and A3 illustrate a life cycle from the start to end of the utility 446. When the utility 446 is started, the utility 446 executes an initializing process, and sets a divisional area flag at “0” (step A1). Specifically, the divisional area flag “0” is indicative of the state S1 which is not the divisional area display mode.

The utility 446 acquires operation information from the mouse driver 444 in accordance with an input operation of the pointing device by the user (step A2). The operation information includes, for example, data indicative of a direction of movement or a distance of movement corresponding to an operation of moving the position of the mouse 25, data indicative of an operation amount of a wheel provided in the mouse 25, and data indicative of pressing of a mouse button (right button, left button).

The utility 446 determines whether the user operation is an operation for terminating the utility 446, based on the operation information from the mouse driver 444.

When it has been determined that the user operation is the operation for terminating the utility 446 (Yes in step A3), the utility 446 terminates the process. On the other hand, when it has been determined that the user operation is not the operation for terminating the utility 446 (No in step A3), the utility 446 determines whether the user operation is an operation for instructing a transition to the divisional area display mode, that is, a starting trigger of the divisional area display mode for displaying divisional areas.

It is assumed that the operation which is the starting trigger of the divisional area display mode is predetermined, for example, as a mouse gesture. The mouse gesture can be defined, for example, by a combination of operations of the right button and left button of the mouse 25, or a combination of a mouse button and a moving operation of the mouse 25.

In the meantime, the operation which is the starting trigger of the divisional area display mode is not limited to the mouse gesture, and may be, for example, an operation on a purpose-specific button provided on the mouse 25, an operation by a combination between an operation of the mouse 25 (a moving operation or a button pressing operation) and an operation of the keyboard 13, or an operation of a specific key of the keyboard 13 (one key or a combination of plural keys).

If the operation information is not indicative of the starting trigger of the divisional area display mode (No in step A4) but is indicative of an operation of moving the position of the mouse pointer (Yes in step A11), the utility 446 determines whether the divisional area flag is “1” or not.

If the divisional area flag is not “1”, that is, if the divisional area flag is not indicative of the divisional area display mode (No in step A12), the utility 446 draws a mouse pointer on the screen of the display 15 in accordance with data indicative of a distance of movement which is represented by the operation information (step A13). Specifically, the utility 446 displays a mouse pointer such that the mouse pointer is successively moved, as shown in FIG. 5, in accordance with the operation amount of the pointing device.

On the other hand, if the operation information from the mouse driver 444 is indicative of the starting trigger of the divisional area display mode (Yes in step A4), the utility 446 transitions to a determination process of “enable/disable” of the divisional area display mode.

In the determination process of “enable/disable” of the divisional area display mode, the utility 446 first acquires information of the resolution (display device information) of the display unit 32 from the OS 441 or display driver 443 (step A5), and then acquires from the OS 441 a DPI setup value indicative of the enlargement ratio of icons and characters on the screen (step A6).

Next, the utility 446 determines whether or not to transition to the divisional area display mode, based on the display device information and the DPI setup value. Specifically, the utility 446 determines whether the operability of the user for the mouse pointer is improved by displaying divisional areas on the screen and moving the mouse pointer in units of a divisional area.

In this determination, the following criteria can be used. For example, when the display unit 32 has a low resolution of, e.g. 1366×768, the divisional area display mode is disabled. Specifically, when the resolution of the display unit 32 is low, the necessity for quickly moving the mouse pointer is not high, and thus the transition to the divisional area display mode is disabled.

In addition, for example, when the display unit 32 has a high resolution of, e.g. 3840×2160 and the DPI setup value of the OS 441 is 100%, the divisional area display mode is enabled. Specifically, since the resolution of the display unit 32 is high, it is necessary to quickly move the mouse pointer. Furthermore, since the display size of an object such as an icon is not large, it is necessary to move the mouse pointer by a normal operation. It is thus determined that the transition to the divisional area display mode is enabled.

In addition, for example, when the display unit 32 has a relatively high resolution of, e.g. 2560×1440, but the DPI setup value of the OS 441 is indicative of a high enlargement ratio of, e.g. 150%, the divisional area display mode is disabled. Specifically, the resolution of the display unit 32 does not greatly degrade the operability for moving the mouse pointer and the display size of an object such as an icon is large. Thus, even if the speed of the mouse pointer corresponding to the operation amount of the pointing device is adjusted in accordance with the resolution, the operation for designating the object does not become difficult. Therefore, it is determined that the transition to the divisional area display mode is disabled.

Besides, the divisional area display mode is enabled, for example, in the case of a mode in which two screens of the display units 32 and 33 are coupled and used (a mode in which a logically single screen is displayed on two displays). In the meantime, in this mode, if the resolutions of the display units 32 and 33 are 1920×1080 and 1600×900 and the DPI setup value is 100%, the divisional area display mode may be enabled. Specifically, in the mode in which the plural display units 32 and 33 are coupled and used, since the sum of resolutions is larger than the case of using a single display unit, it is necessary to quickly move the mouse pointer. It is thus determined that the transition to the divisional area display mode is enabled.

The utility 446 may have table-format data in which the resolution of the display unit (display) and the DPI setup value are combined with plural different values and the “enable” or “disable” of the transition to the divisional area display mode is indicated with respect to each of combinations. By referring to the table, the utility 446 determines whether the transition to the divisional area display mode is enabled or disabled.

Alternatively, the utility 446 can calculate a determination value by a calculation formula using the resolution of the display unit (display) and the DPI setup value, and can determined, based on this determination value, whether the transition to the divisional area display mode is “enable” or “disable”.

If the determination result of “enable/disable” of the divisional area display mode is “enable” (Yes in step A7), the utility 446 sets the divisional area flag at “1” (step A8). Specifically, the divisional area flag “1” is indicative of the state S2 which is the divisional area display mode. The personal computer 10 transitions from the state S1 to state S2.

Next, the utility 446 calculates an optimal division number of divisional areas for the display 15 of the display unit 32 which is currently connected to the personal computer 10, based on the resolution of the display unit (display) and the DPI setup value (step A9). For example, when the resolution of the display 15 is high and the DPI setup value is low, the number of divisional areas is increased, since many objects would exist in one area if the number of visional areas is decreased. Conversely, when the resolution of the display 15 is low, the number of visional areas is decreased. In addition, when a plurality of display units 32 are used as a single horizontally elongated screen, the division number in the horizontal direction may be increased.

As regards the division number of divisional areas, too, the utility 446 may calculate this division number by referring to table-format data or by a calculation formula, as described above. The division number of divisional areas is properly set so as to be able to perform quickly movement in the divisional area display mode and to easily select an object existing in a divisional area in this divisional area at the destination of movement of the mouse pointer, in accordance with an operation of the pointing device by the user.

Next, in accordance with the calculated division number, the utility 446 draws divisional areas on the display 15 of the display unit 32 (step A10). For example, as shown in FIG. 6, the utility 446 sets divisional areas by drawing lines 60 for demarcating the divisional areas in the screen. Incidentally, the process of drawing may not only be executed by the utility 446, but the utility 446 may also instruct the display driver 443 to execute the process of drawing.

To begin with, the utility 446 determines whether the operation information, which has been acquired from the mouse driver 444, is indicative of an instruction to move the position of the mouse pointer (step A3, A11). When it has been determined that the operation information is indicative of the instruction to move the position of the mouse pointer (Yes in step A11), the utility 446 determines whether the divisional area flag is “1” or not, that is, whether the divisional area flag is indicative of the divisional area display mode (state S2).

If the divisional area flag is not “1”, that is, if the divisional area flag is not indicative of the divisional area display mode (No in step A12), the utility 446 draws a mouse pointer on the screen of the display 15 in accordance with data indicative of a distance of movement which is represented by the operation information (step A13).

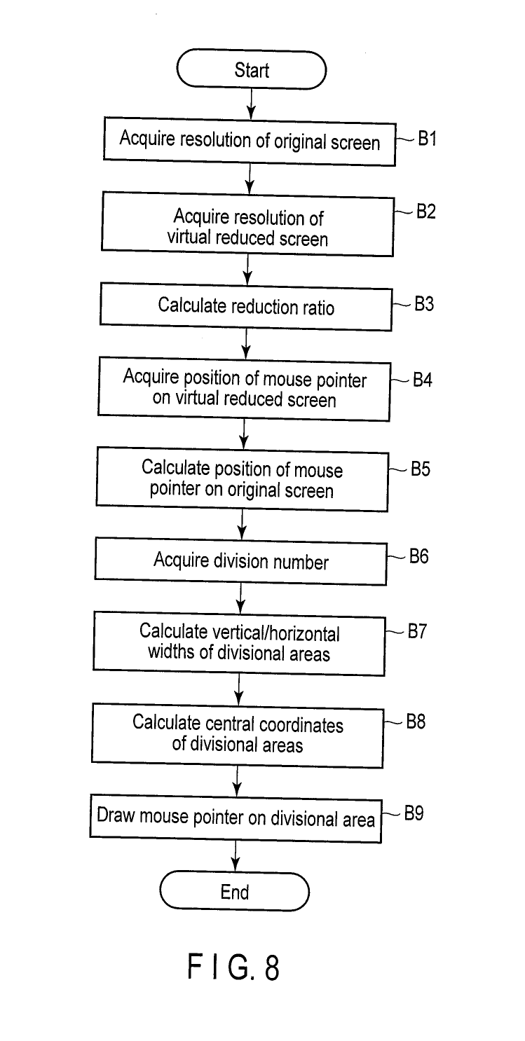

On the other hand, if the divisional area flag is “1”, that is, if the divisional area flag is indicative of the divisional area display mode (Yes in step A12), the utility 446 draws a mouse pointer on a divisional area corresponding to the operation amount of the pointing device, based on the operation information acquired from the display driver 443 (step A14). In the divisional area display mode, if the operation of the pointing device is continued (No in step A15), the mouse pointer is successively moved in different divisional areas in accordance with the operation amount of the pointing device, as shown in FIG. 6. A description will be given later of a process of drawing a mouse pointer in the divisional area display mode (see FIG. 8).

On the other hand, when the operation information acquired from the mouse driver 444 is indicative of a user operation indicating the end of the divisional area display mode, the utility sets the divisional area flag “0” and terminates the divisional area display mode (step A16) by using this user operation as an end trigger (Yes in step A15). Specifically, the state of the personal computer 10 is transitioned to the state S1. If the divisional area display mode is terminated, the personal computer 10 can successively move the mouse pointer in units of a number of pixels corresponding to the operation amount of the pointing device, as shown in FIG. 5.

The user operation indicating the end of the divisional area display mode is, for example, a click operation by the mouse button (right button or left button) of the mouse 25. By setting a simple operation, such as a click operation, to be the end trigger, the divisional area display mode can easily be released after quickly moving the mouse pointer to a divisional area including a target object in the divisional area display mode. By releasing the divisional area display mode, the mouse pointer can be finely moved. Thus, the position of the mouse pointer can be precisely and easily moved, relative to an object such as an icon.

FIG. 8 is a flowchart illustrating the details of the process of drawing a mouse pointer in units of a divisional area (step A14 in FIG. 7) in the divisional area display mode in the embodiment.

In the mouse pointer drawing process, the utility 446 calculates a position where a mouse pointer is to be drawn (steps B1 to B8), and draws the mouse pointer at the calculated position in the screen via the mouse driver 444 or display driver 443 (step B9).

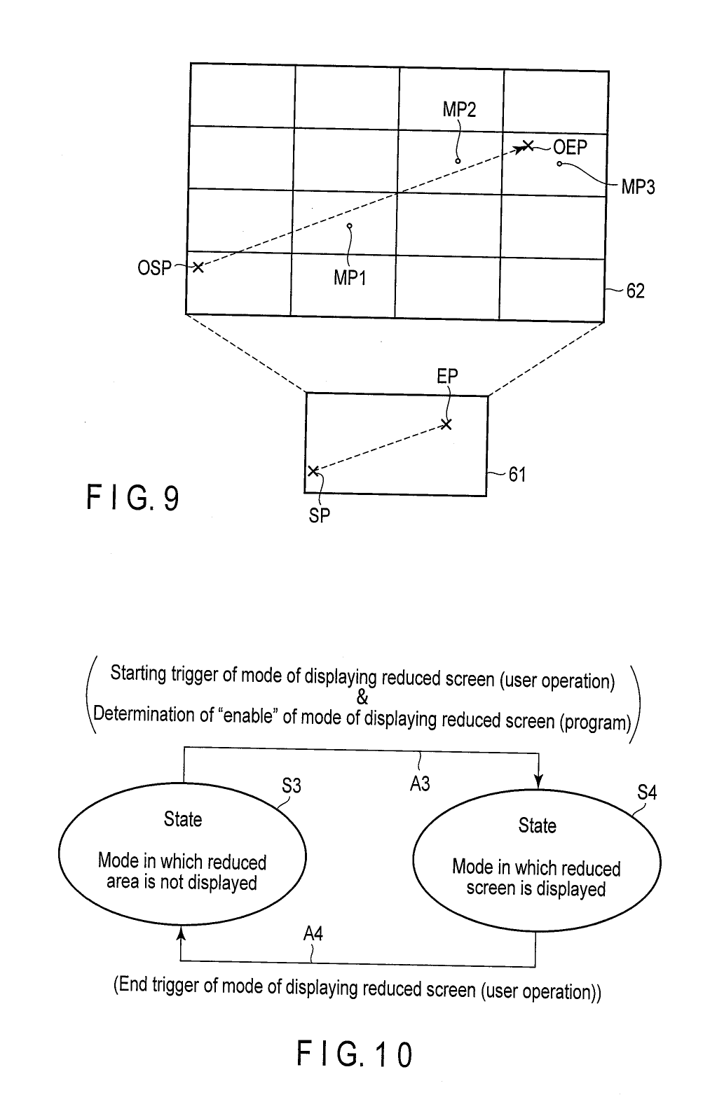

FIG. 9 is a view which conceptually illustrates a calculation method of a position of drawing of a mouse pointer in the embodiment. For example, the utility 446 assumes a virtual reduced screen 61, and converts a position of a virtual mouse pointer in the reduced screen 61 to a position in the screen of the actual display (original screen).

The resolution of the virtual reduced screen 61 is set at, for example, such a resolution that the mouse pointer can be moved between both ends of the screen when the user has moved the pointing device over a distance, over which the pointing device can easily be operated. For example, it is desirable to set the resolution at such a resolution that a mouse pointer existing at the left end of the screen can move to the right end of the screen when the user has moved the mouse 25 over several centimeters.

Incidentally, such a configuration may be adopted that the resolution of the virtual reduced screen 61 can be set, for example, by a setup function which is provided by the utility 446. In the setup function, a setup item for setting the resolution of the virtual reduced screen 61 is displayed, and the resolution can be set by the user's designation on the setup item.

The following method, for example, may be used in order to calculate the position of the mouse pointer in a divisional area.

To start with, the utility 446 acquires the resolution of an original screen 62 (display 15) shown in FIG. 9 and the resolution of the virtual reduced screen 61 (step B1, B2), and calculates the ratio (hereinafter “reduction ratio”) between the two resolutions (step B3).

Next, the utility 446 acquires the position of the mouse pointer on the virtual reduced screen 61 (step B4) and calculates, by using the reduction ratio, the corresponding position of the mouse pointer on the original screen 62 (step B5). Specifically, the utility 446 converts the position of the mouse pointer on the virtual reduced screen 61 to the position of the mouse pointer on the original screen 62. At this time point, only the calculation is executed, and the mouse pointer is not drawn.

Subsequently, the utility 446 acquires a division number of the original screen 62 (step B6), and calculates the vertical and horizontal widths of divisional areas, by also taking into account the resolution of the original screen 62 (step B7).

At last, the utility 446 calculates the position of the mouse pointer on the divisional area, based on the position of the mouse pointer on the original screen 62 and the vertical and horizontal widths of divisional areas. Specifically, the utility 446 determines in which of the plural divisional areas the mouse pointer is included, and calculates the central coordinates of the corresponding divisional area (step B8). In the meantime, the initial value of the position of the mouse pointer on the virtual reduced screen 61 can be calculated from the position of the mouse pointer on the original screen 62 and the reduction ratio.

The utility 446 draws the mouse pointer on the screen of the display 15 such that the mouse pointer points the calculated central coordinates of the divisional area (step B9).

The example shown in FIG. 9 illustrates the state in which the mouse pointer is moved from a point SP to a point EP on the virtual reduced screen 61 by the operation of the pointing device. In this case, the positions of the mouse pointer from the point SP to point EP on the virtual reduced screen 61 are converted to positions of the mouse pointer from a point OSP to a point OEP on the original screen 62. Then, it is determined in which divisional areas the positions of the mouse pointer are included, and the mouse pointer is drawn in accordance with, for example, central coordinates MP1, MP2 and MP3 of divisional areas shown in FIG. 9.

In the meantime, the method of drawing the mouse pointer, as illustrated in FIG. 8 and FIG. 9, is merely an example, and it is possible to draw the mouse pointer by using other calculation methods.

As described above, in the personal computer 10 of the embodiment, by the transition to the divisional area display mode, the display position of the mouse pointer is moved more quickly than at a normal time in accordance with the moving operation of the pointing device. Thus, even when the mouse pointer is to be greatly moved on the screen, the move of the mouse pointer is completed by a short-distance moving operation of the pointing device by the user, and it is possible to eliminate troublesomeness due to plural times of moving operations. In the divisional area display mode, the divisional areas are displayed on the screen, and the mouse pointer is drawn in a manner to intermittently move to the centers of the divisional areas. Then, after the mouse pointer is moved to the target divisional area, the divisional area display mode is released. Thereby, an object such as an icon in the divisional area can exactly be designated by the mouse pointer by a normal input operation. Thus, the operability of the user and the feeling of the operation can be improved.

In addition, in the embodiment, when a transition is made to the divisional area display mode, the size of the divisional areas is optimally set in accordance with the present conditions such as the resolution of the display and the DPI setup value at the time of the transition. Thus, there is no need to perform an operation, such as a manual setup by the user, for the use with an optimal size of divisional areas, and labor-saving can be realized.

Besides, since the “enable/disable” of the divisional area display mode is automatically determined when the starting trigger has occurred, no transition occurs to the divisional area display mode in the situation in which display of divisional areas is needless, and no degradation occurs in operability.

In the above description, in the divisional area display mode (state S2), when the mouse pointer is moved, the mouse pointer is displayed at such a position as to point the central coordinates of each divisional area. Alternatively, the mouse pointer may be drawn at a position other than the central coordinates of the divisional area.

In addition, in the divisional area display mode, as shown in FIG. 6, the lines 60 for demarcating divisional areas are drawn. Alternatively, the lines 60 may not be displayed.

The above-described process has been described as being realized by executing the utility 446 by the control module 40 (e.g. processor). Alternatively, the above-described process may be realized by the mouse driver 444 or an application program for controlling the mouse pointer.

Next, a description is given of a modification of the mode for quickly moving the mouse pointer.

In the above description, when a predetermined user operation has been executed, the utility 446 executes a transition to the divisional area display mode by using this user operation as the starting trigger. In the description below, when a transition has been made to the mode of quickly moving the mouse pointer, the utility 446 displays a reduced screen which is obtained by reducing in size the screen of the display, and controls the position of the mouse pointer which is displayed on the original screen in accordance with the position of the mouse pointer which is moved on the reduced screen. In the description below, the mode of quickly moving the mouse pointer by displaying the reduced screen is described as a reduced screen display mode.

FIG. 10 is a state transition diagram of the personal computer 10 and the program 44 executed in the personal computer 10 in the embodiment.

The personal computer 10 and program 44 make a transition between a state S3 and a state S4 in accordance with conditions A3 and A4. The state S3 is a state which is not in the reduced screen display mode, and the state S4 is a state of the reduced screen display mode.

The condition A3 for a transition from the state S3 to state S4 is a condition that a trigger for starting the reduced screen display mode has occurred as a user operation and the result of the “enable/disable” determination of the mode of displaying the reduced screen by the program 44 (utility 446) is indicative of “enable”.

The condition A4 for a transition from the state S4 to state S3 is a condition that a trigger for ending the reduced screen display mode has occurred as a user operation.

Incidentally, the state S3 is the same as the state S1 which is not the divisional area display mode. Thus, in the state S1, S3, the personal computer 10 can transition to the divisional area display mode when the condition A1 is met, and can transition to the reduced screen display mode when the condition A3 is met. Specifically, in accordance with the difference of the operation that is the starting trigger, the user can selectively use the divisional area display mode or the reduced screen display mode.

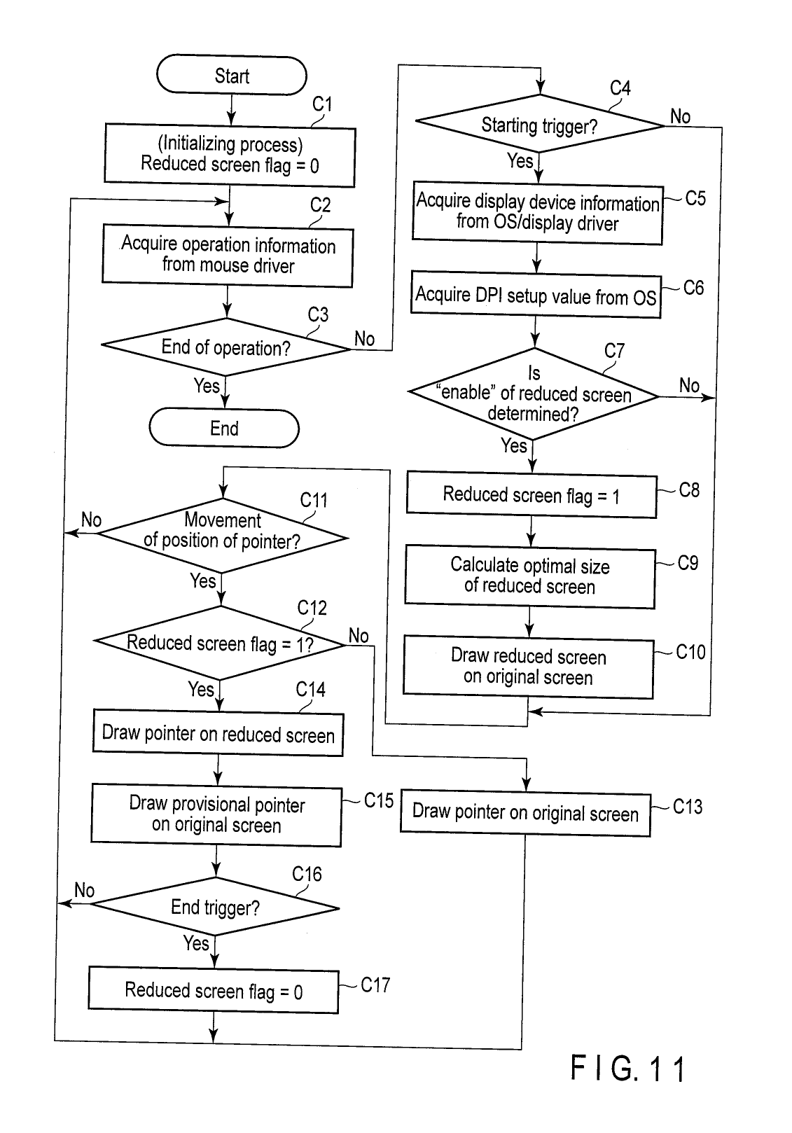

Next, a description is given of the operation of mouse pointer control in the reduced screen display mode in the embodiment. FIG. 11 is a flowchart illustrating an operation of the utility 446 in the embodiment. The personal computer 10 realizes the process of the flowchart of FIG. 11 by executing the utility 446 by the processor or the like. The description below is given of the operation of the utility 446. FIG. 11 illustrates the process in the case of using only the reduced screen display mode.

Steps C1 to C3 in FIG. 11 are executed like steps A1 to A3 in FIG. 7, so a description is omitted here.

Based on the operation information, the utility 446 determines whether the user operation is an operation for instructing a transition to the reduced screen display mode, that is, a starting trigger of the reduced screen display mode for displaying a reduced screen.

Like the starting trigger of the divisional area display mode, the operation which is the starting trigger of the reduced screen display mode may be, for example, a mouse gesture, an operation on a purpose-specific button, an operation by a combination between an operation of the mouse 25 and an operation of the keyboard 13, or an operation of a specific key of the keyboard 13.

If the operation information is not indicative of the starting trigger of the reduced screen display mode (No in step C4), but is indicative of an operation of moving the position of the mouse pointer (Yes in step C11), the utility 446 determines whether the reduced screen flag is “1” or not.

If the reduced screen flag is not “1”, that is, if the reduced screen flag is not indicative of the reduced screen display mode (No in step C12), the utility 446 draws a mouse pointer on the screen of the display 15 in accordance with data indicative of a distance of movement which is represented by the operation information (step C13). Specifically, the utility 446 displays a mouse pointer such that the mouse pointer is successively moved, as shown in FIG. 5, in accordance with the operation amount of the pointing device.

On the other hand, if the operation information from the mouse driver 444 is indicative of the starting trigger of the reduced screen display mode (Yes in step C4), the utility 446 transitions to a determination process of “enable/disable” of the reduced screen display mode.

In the determination process of “enable/disable” of the reduced screen display mode, the utility 446 first acquires information of the resolution (display device information) of the display unit 32 from the OS 441 or display driver 443 (step C5), and then acquires from the OS 441 a DPI setup value indicative of the enlargement ratio of icons and characters on the screen (step C6).

Next, the utility 446 determines whether or not to transition to the reduced screen display mode, based on the display device information and the DPI setup value. Specifically, the utility 446 determines whether the operability of the user for the mouse pointer is improved by displaying the reduced screen and moving the mouse pointer in the reduced screen.

The “enable/disable” determination process, like the determination process in the divisional area display mode, is executed based on the combination of the resolution of the display unit (display) and the DPI setup value, or based on whether a mode in which two screens of the display units 32 and 33 are coupled and used is set or not.

If the determination result of “enable/disable” of the reduced screen display mode is “enable” (Yes in step C7), the utility 446 sets the reduced screen flag at “1” (step C8). Specifically, the reduced screen flag “1” is indicative of the state S4 which is the reduced screen display mode. The personal computer 10 transitions from the state S3 to state S4.

Next, the utility 446 calculates the optimal size of the reduced screen for the display 15 of the display unit 32 which is currently connected to the personal computer 10, based on the resolution of the display unit (display) and the DPI setup value (step C9). For example, when the resolution of the display 15 is high and the DPI setup value is low, the size of the reduced screen is increased, since the designation of an object by the mouse pointer becomes difficult if the size of the reduced screen is decreased. Conversely, when the resolution of the display 15 is low, the size of the reduced screen can be decreased.

As regards the optimal size of the reduced screen, like the case of the divisional area display mode, this optimal size may be calculated by referring to table-format data which is preset in the utility 446 or by a calculation formula.

Next, in accordance with the calculated optimal size of the reduced screen, the utility 446 draws a reduced screen on the display 15 of the display unit 32 (step C10).

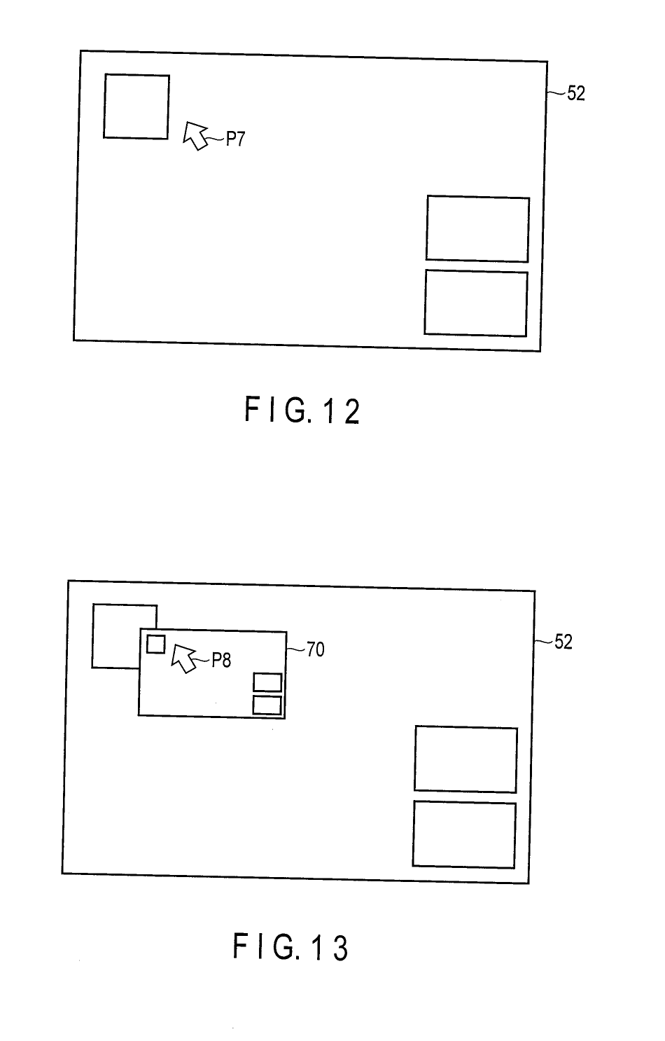

FIG. 12 and FIG. 13 illustrate a display example of the reduced screen in the embodiment. It is assumed that a starting trigger for a transition to the reduced screen display mode has occurred when a mouse pointer P7 is displayed on the display 15, for example, as shown in FIG. 12. In this case, as shown in FIG. 13, the utility 446 displays a reduced screen 70 which is obtained by reducing to an optimal size the screen which is displayed on the display 15 at the time of the transition to the reduced screen display mode. As shown in FIG. 13, the display position of the reduced screen 70 is determined such that the position of the mouse pointer P7, which is displayed on the display 15 at the time of the transition to the reduced screen display mode, agrees with the position of a mouse pointer P8 which is displayed on the reduced screen 70. The position of the mouse pointer P8, which is displayed on the reduced screen 70, is relatively equal to the position of the mouse pointer P7 which is displayed on the display 15 in FIG. 12.

Incidentally, the process of drawing the reduced screen 70 may not only be executed by the utility 446, but the utility 446 may also instruct the display driver 443 to execute this process of drawing.

The utility 446 determines whether the operation information, which has been acquired from the mouse driver 444, is indicative of an instruction to move the position of the mouse pointer (step C3, C11). When it has been determined that the operation information is indicative of the instruction to move the position of the mouse pointer (Yes in step C11), the utility 446 determines whether the reduced screen flag is “1” or not, that is, whether the reduced screen flag is indicative of the reduced screen display mode (state S4).

If the reduced screen flag is not “1”, that is, if the reduced screen flag is not indicative of the reduced screen display mode (No in step C12), the utility 446 draws a mouse pointer on the screen of the display 15 in accordance with data indicative of a distance of movement which is represented by the operation information (step C13).

On the other hand, if the reduced screen flag is “1”, that is, if the reduced screen flag is indicative of the reduced screen display mode (Yes in step C12), the utility 446 draws a mouse pointer in the reduced screen 70 in a manner to move in accordance with the operation amount of the pointing device, based on the operation information acquired from the display driver 443 (step C14). In addition, the utility 446 draws a provisional mouse pointer on the original screen in an interlocking manner such that the relative position of the provisional pointer agrees with the position of the mouse pointer in the reduced screen 70 (step C15).

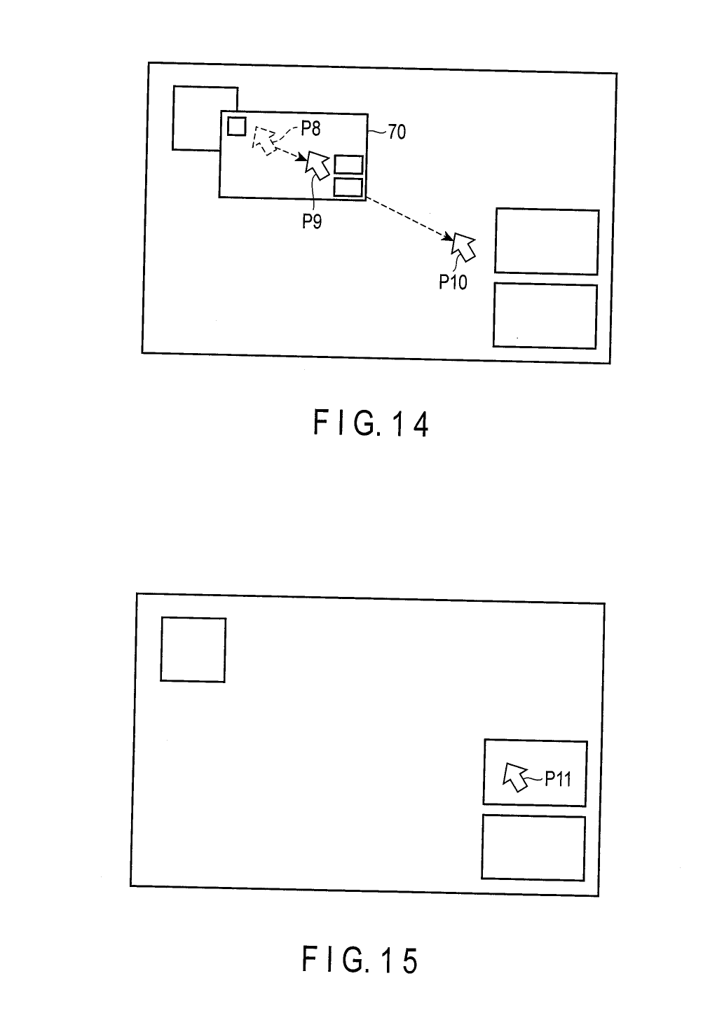

FIG. 14 illustrates an example of a mouse pointer P9 which is moved on the reduced screen 70, and a provisional mouse pointer P10 which is displayed on the original screen of the display 15. FIG. 14 shows the example in which the pointer P8 of the reduced screen 70 has been moved to the position of the mouse pointer P9 in accordance with an operation of the pointing device.

In the meantime, the utility 446 moves the mouse pointer P8 in the reduced screen 70 in accordance with the operation of moving the pointing device, in the same manner as in the original screen. Specifically, when the pointing device has been moved for a predetermined distance, the distance of movement of the mouse pointer in the reduced screen 70 is equal to the distance of movement of the mouse pointer (e.g. mouse pointer P7 in FIG. 12) in the original screen. Accordingly, the user can move the mouse pointer in the reduced screen 70 by operating the pointing device, with the same feeling of operation as before the transition to the reduced screen display mode.

On the other hand, since the provisional pointer P10, which is displayed on the original screen, is drawn in an interlocking manner such that the relative position of the provisional pointer P10 agrees with the position of the mouse pointer which is displayed on the reduced screen 70, the provisional pointer P10 moves quickly.

In the reduced screen display mode, if the operation of the pointing device is continued (No in step C16), the mouse pointer is moved on the reduced screen 70 in accordance with the operation amount of the pointing device, and the provisional pointer is moved on the original screen. In the reduced screen display mode, since the provisional mouse pointer is displayed in the original screen, the user can clearly identify the position of the mouse pointer in the original screen while performing the operation of moving the mouse pointer in the reduced screen.

On the other hand, when the operation information acquired from the mouse driver 444 is indicative of a user operation indicating the end of the reduced screen display mode, the utility 446 sets the reduced screen flag “0” and terminates the reduced screen display mode (step C17) by using this user operation as an end trigger (Yes in step C16). Specifically, the state of the personal computer 10 is transitioned to the state S3. If the reduced screen display mode is terminated, the personal computer 10 turns off the display of the reduced screen 70 and returns to the display state of the original screen. Thus, the personal computer 10 can successively move the mouse pointer in units of a number of pixels corresponding to the operation amount of the pointing device.

FIG. 15 illustrates an example of a screen on which the reduced screen display mode has been terminated. In FIG. 15, an object is designated by a mouse pointer P11. By using the reduced screen display mode, the user can move the mouse pointer in the reduced screen 70 and can quickly move the provisional mouse pointer P10 to the vicinity of the object. Thereafter, by releasing the reduced screen display mode, as shown in FIG. 15, the object can exactly be designated by the mouse pointer P11.

Incidentally, the user operation indicating the end of the reduced screen display mode can be made the same as, for example, the user operation indicating the end of the divisional area display mode. Specifically, by using a simple operation as an end trigger, the reduced screen display mode can easily be released after the mouse pointer is quickly moved to the vicinity of the target object in the reduced screen 70 in the reduced screen display mode. By releasing the reduced screen display mode, the mouse pointer can be finely moved, and thus the position of the mouse pointer can exactly and easily be moved to the object such as an icon.

In the meantime, when the operation of the pointing device is continued even after the pointer P9 has been moved to an end portion of the reduced screen 70, the display content on the reduced screen 70 may be scrolled. For example, the utility 446 causes the application 445, which displays the screen, or the OS 441, to scroll the display on the original screen of the display 15, and to scroll the display content of the reduced screen 70 in an interlocking manner. Thereby, the position designated by the mouse pointer in the reduced screen 70 can be interlocked with the position of the provisional mouse pointer in the original screen.

Thus, by using the reduced screen display mode, the same advantageous effects as with the above-described divisional area display mode can be obtained. A detailed description thereof is omitted.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
an input configured to receive operation information corresponding to an operation of a pointing device;
an output configured to output an image to be displayed on a display; and
a controller configured to:
set a plurality of divisional areas on a screen of the display in accordance with a resolution of the display, and
move a mouse pointer in units of a divisional area of the plurality of divisional areas in accordance with the operation information.

2. The electronic device of claim 1, wherein the controller is further configured to set the plurality of divisional areas, based on data indicative of an enlargement ratio of an object displayed on the display.

3. The electronic device of claim 2, wherein the controller is further configured to:
determine whether setup of the plurality of divisional areas is enabled, based on the resolution and the enlargement ratio; and
set the plurality of divisional areas when the setup is enabled.

4. The electronic device of claim 2, wherein the controller is further configured to:
calculate a division number of the plurality of divisional areas, based on the resolution and the enlargement ratio; and
set the plurality of divisional areas in accordance with the division number.

5. The electronic device of claim 1, wherein the controller is further configured to make a speed for moving the mouse pointer in units of the divisional area to be higher than a speed for moving the mouse pointer in accordance with the operation information before setting the plurality of divisional areas.

6. The electronic device of claim 1, wherein the controller is further configured to:
determine a divisional area of the plurality of divisional areas that includes a destination of movement of the mouse pointer corresponding to the operation information; and
display the mouse pointer at a position in the determined divisional area.

7. A pointing device control method comprising:
receiving operation information corresponding to an operation of a pointing device;
setting a plurality of divisional areas on a screen of a display in accordance with a resolution of the display; and
moving a mouse pointer in units of a divisional area of the plurality of divisional areas in accordance with the operation information.

8. The pointing device control method of claim 7, further comprising setting the plurality of divisional areas, based on data indicative of an enlargement ratio of an object displayed on the display.

9. The pointing device control method of claim 8, further comprising determining whether setup of the divisional areas is enabled, based on the resolution and the enlargement ratio,
wherein the plurality of divisional areas are set when the setup is enabled.

10. The pointing device control method of claim 8, further comprising calculating a division number of the plurality of divisional areas, based on the resolution and the enlargement ratio,
wherein the plurality of divisional areas are set in accordance with the division number.

11. The pointing device control method of claim 7, wherein when the mouse pointer is moved in units of the divisional area, a speed for moving the mouse pointer is made to be higher than a speed for moving the mouse pointer in accordance with the operation information before setting the plurality of divisional areas.

12. A computer-readable, non-transitory storage medium having stored thereon a computer program which is executable by a computer, the computer program controlling the computer to execute functions of:
receiving operation information corresponding to an operation of a pointing device;
setting a plurality of divisional areas on a screen of a display in accordance with a resolution of the display; and
moving a mouse pointer in units of a divisional area of the plurality of divisional areas in accordance with the operation information.

13. The storage medium of claim 12, wherein the computer program further controls the computer to execute a function of setting the plurality of divisional areas, based on data indicative of an enlargement ratio of an object displayed on the display.

14. The storage medium of claim 13, wherein the computer program further controls the computer to execute functions of:
determining whether setup of the plurality of divisional areas is enabled, based on the resolution and the enlargement ratio; and
setting the plurality of divisional areas when the setup is enabled.

15. The storage medium of claim 13, wherein the computer program further controls the computer to execute functions of:
calculating a division number of the plurality of divisional areas, based on the resolution and the enlargement ratio; and
setting the plurality of divisional areas in accordance with the division number.

16. The storage medium of claim 13, wherein the computer program further controls the computer to execute a function of making, when the mouse pointer is moved in units of the divisional area, a speed for moving the mouse pointer to be higher than a speed for moving the mouse pointer in accordance with the operation information before setting the plurality of divisional areas.
